(19) United States
(12) Patent Application Publication
(10) Pub. No.: US 2017/0148051 A1
(43) Pub. Date: May 25, 2017

(54) SYSTEMS AND METHODS FOR ONE-TO-ONE ADVERTISING MANAGEMENT

(71) Applicant: GroupM Worldwide LLC, New York City, NY (US)

(72) Inventors: Saeed R. Bagheri, New York City, NY (US); Seyed Hanif Mahboobi, New York City, NY (US)

(21) Appl. No.: 14/946,236

(22) Filed: Nov. 19, 2015

(51) Int. Cl. G06Q 30/02; G06N 99/00; G06F 17/30

(52) U.S. Cl. CPC G06Q 30/0246; G06Q 30/0244; G06Q 30/0269; G06F 17/30368; G06N 99/005

(57) ABSTRACT

Customer targeted advertising may be efficiently planned based on different demographic and behavioral segments. A method may use event-level data to model conversion attribution based on different dimensions. These dimensions may include channel, content, placement and every other aspect of advertising. Multiple population segments of users may be identified and attribution modeling performed independently for each population segment. The attribution modeling may be implemented in a plurality of approaches such as independent or coupled modeling. Coupled attribution modeling may be capable of modeling the combined effect of multiple dimensions. The results of attribution modeling may then be used to plan optimum advertising placement with the highest attribution for each population segment.

### FIELD OF TECHNOLOGY

The present disclosure relates to planning and implementing targeted marketing campaigns based on event-level data and modeling the efficacy of the campaigns based on different dimensions of the placed advertisement.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Delivering an efficient advertisement to potential customers is of great importance in marketing. Simply relying on a few dimensions such as location or media outlet without considering other attributes of each user may not lead to efficient targeting of those potential customers. Further, the overall effectiveness of an advertising campaign cannot be fully determined without evaluating different implementations. For example, it is normally desired to understand the contribution of each channel, site (e.g., television, webpage, etc.), and content of the advertisement in user conversion.

Traditionally, attribution modeling may be used to determine the efficacy of different dimensions of an advertising campaign. However, known attribution modeling techniques only evaluate different dimensions across an entire population of potential customers in a campaign. Obviously, any model which is trained based on the entire population may not be an optimal evaluation tool for different segments of the population. For example, members of the population with different occupations or education levels may be attracted to different channels or contents of an advertising campaign. Also, the combined effects of multiple advertising dimensions are not taken into account using traditional attribution models which evaluate an entire population. For example, using attribution modeling, one may find that webpage #1 is more effective than webpage #2. Another independent model may find that ad #2 is more effective than ad #1. However, independent findings do not necessarily imply that using ad #2 on webpage #1 will be the most efficient of all four possible combinations.

Others have attempted optimized targeted advertising, but suffer several shortcomings. For example, in U.S. Pat. No. 8,560,388, Yeh et al. proposes a user targeting approach based on user location. The population segmentation techniques described by Yeh et al. are solely based on geolocation information. In another example, U.S. Pat. No. 8,689,136 to Ting et al. propose a system for backend conversion attribution of an advertisement served to a user device. In particular, the described embodiments track user activities and keep user records for conversion attribution modeling. However, the proposal only describes how to track the user activities in order to collect the data required for an attribution model. Likewise, U.S. Patent Application No. 2010/0023392 to Merriman et al., only describes methods and apparatuses for targeting the delivery of advertisements over a network such as the Internet and U.S. 2012/0290373 to Ferzacca et al. only describe a computer implemented method of determining commission payout for marketing partners based on their contribution to a marketing interactions that resulted in customer acquisition.

Hence, there is a need for a system and method to customize attribution modeling for various population segments.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

Different dimensions of an advertising campaign may be coupled such that understanding the efficacy of the campaign may be achieved by modeling the interaction between these couplings. Not only is the overall efficiency and conversion rate of a campaign important, but also the combined effectiveness of different dimensions of the campaign. The systems and methods described herein use population segmentation and attribution modeling to optimize the targeting efficiency in advertisement delivery.

In some embodiments, a method for delivering data to potential customers/users based on a plurality of customizable dimensions may comprise gathering data corresponding to the potential customers including user ad impression, activity log files, and other user data. The method may also include, for a subset of users having a registered profile, determining each users' attributes and matching those attributes to a population segment. For unregistered users, gathered data may be analyzed to determine their most probable attributes using a probabilistic approach. The method may then group the users based on their attributes. For each group of users, the method may perform attribution modeling to determine the efficacy of an advertisement or advertising campaign (e.g., the rate at which users purchase the good or service depicted by the advertisement or campaign, the share of credit that should be assigned to each advertising hyper-placement, or other measures of efficacy). The method may then store a list of top-attributed channel/site/content for each population segment or the users. Then, for future user targeting, the population group of each user may be estimated and a corresponding highest attributed advertising hyper-placement may be delivered.

In further embodiments, a method or system may target users by optimizing, executing and monitoring one-to-one message delivery of an advertising hyper-placement along a plurality of customizable dimensions. A networked system may comprise a processor, a memory and an input-output circuit for enabling a modeling module to deliver an advertising hyper-placement along a plurality of customizable dimensions, the processor being physically configured according to computer executable instructions of the method, as follows. The method may gather and process user ad impression, activity log files and user data for a plurality of users. Then, for each user of a subset of the plurality of users that correspond to a registered profile, the method may determine registered user attributes and a population segment. For each user that is not a member of the subset, the method may determine unregistered user attributes using a probabilistic approach and group the plurality of users into a plurality of groups based on the registered user attributes and the unregistered user attributes. The method may then assign one or more advertising hyper-placements of an advertising campaign to at least one of the plurality of groups and determine, using attribution modeling, a share of credit to assign to each advertising hyper-placement corresponding to each of the plurality of groups. Then the method may assign further advertising hyper-placements to at least one of the plurality of groups based on the determined share of credit. The share of credit may include a value indicating a conversion rate for an advertising hyper-placement assigned to a group of the plurality of groups.

In still further embodiments, a method may deliver targeted advertisements along a plurality of customizable dimensions. For example, the method may determine user attributes based on user data corresponding to a plurality of users, the user data from interactions with one or more of online media and offline media of the plurality of users. The method may also determine a plurality of population segments based on the user attributes, wherein each of the plurality of population segments corresponds to at least one of the user attributes for each user of the plurality of users and analyze each population segment separately from the plurality of population segments. Further, the method may select an advertising hyper-placement for each of the plurality of users based on the population segment analysis.

### BRIEF DESCRIPTION OF THE DRAWINGS

FIG. 1 illustrates an embodiment of an exemplary system for targeted advertising management;

FIG. 2 illustrates an exemplary flowchart of a method for use on the system for targeted advertising management;

FIG. 3 illustrates a further exemplary flowchart that illustrates some embodiments of steps of a population segmentation module as executed by the system for targeted advertising management; and

FIG. 4 illustrates an exemplary computing system for use within the system for targeted advertising management.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

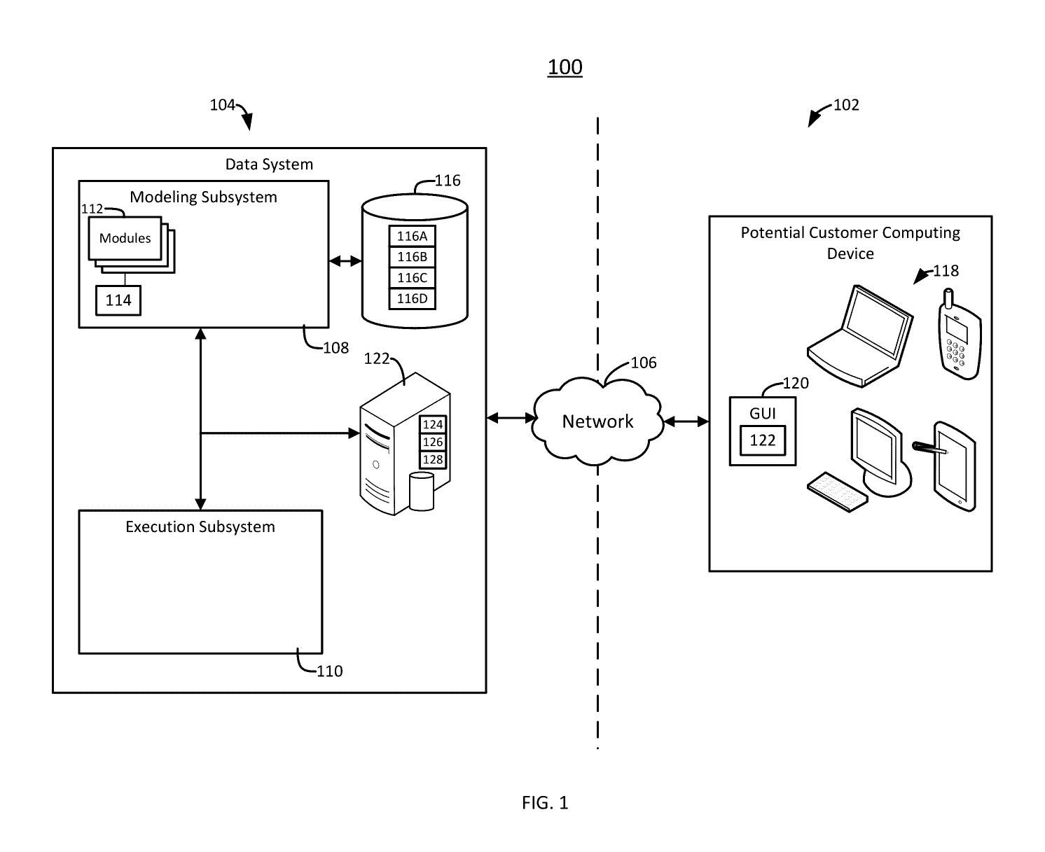

FIG. 1 generally illustrates one embodiment for a system for targeted advertising management 100. The system 100 may include front end components 102 and/or backend components 104 in communication with each other via a communication link 106 (e.g., computer network, internet connection, etc.). The system 100 may include various software or computer-executable instructions and hardware components or modules that may employ the software and instructions to manage the delivery of advertising content to potential customers as described herein. The various modules may be implemented as computer-readable storage memories containing computer-readable instructions (i.e., software) for execution by a processor of the computer system 100 within a specialized computing device. The modules may perform the various tasks associated with targeted delivery of advertising content and other data, as herein described. The computer system 100 may also include both hardware and software applications, as well as various data communications channels for communicating data between the various hardware and software components.

The system 100 may be comprised of two main subsystems or modules: modeling 108 and execution 110. Generally, the modeling subsystem 108 may include a set of computer-executable steps or modules 112. These modules 110 may include instructions that, upon execution by one or more computer processors 114, analyze data from a data warehouse 116 to determine targeting or planning parameters, as described below. In some embodiments, the data analysis is performed offline (e.g., during periods when the system 100 has completed a task of sending advertising or other data to potential customers as determined by the modeling subsystem 108), or when such sending or determining is otherwise not being performed. The modules 112 of the modeling subsystem 108 may analyze large datasets resulting in the plurality of attribution modeling outcomes 116A which may be stored in a data warehouse 116. This set of modules or processes 112 can be run occasionally when there is a need to update the model to consider new implementations of advertising dimensions. In some embodiments, advertising dimensions may include channel, site, ad content (creative), ad placement, and other aspects. Channels may include a displayed ad, a paid search, social network, TV, radio, etc. Each channel may also be subdivided into more granular dimensions. For example, a first level of subdivision for a digital display channel may be the site web page and the first level of subdivision for the TV channel may be a particular television network.

Different data types from different sources are stored in the database 116. These include 1^{st}, 2^{nd} and 3^{rd} party datasets (116B, 116C, and 116D, respectively). The 1^{st} party data 116B may include information collected from clients' own users. For example, in digital display advertising, the 1^{st} party data can include event log files gathered from users who have any online or offline interaction with an advertising campaign of interest (i.e., client's own data). The 2^{nd} party data 116C may be similar to 1^{st} party data in terms of content. It may be available to be used by a given client indirectly through opt-in agreements of other clients. 3^{rd} party data 116D may refer to other data sets that are generally available to augment the 1^{st}/2^{nd} party data 116B/116C for the purpose of the embodiments of the system 100 and methods described herein. These data sets 116B, 116C, and 116Ds, among other things, may cover user interaction with online and/or offline media such as TV ads, online ad impressions, clicks, paid search and performing a certain activity. An activity or conversion can be considered as a predefined action taken by user. For example, this action can be requesting a product brochure, exploring the product specification, and finally purchasing merchandise or a service as a result of the sent data.

Various entities at the back end 104 communicate advertising and other data to the front end components 102 via the computer network 106 and the execution subsystem 110 from execution of the various modules 112 of the modeling subsystem 108. Front end components may include various computing devices 118 such as a personal computer, smart phone, tablet computer, or other suitable computing or mobile device. Each device may include a display for presenting a GUI 120 may communicate with the data system 104 through the Internet 106 and/or other type of suitable network (local area network (LAN), a metropolitan area network (MAN), a wide area network (WAN), a mobile, a wired or wireless network, a private network, a virtual private network, etc.). The network 106 may facilitate any type of data communication via any standard or technology (e.g., GSM, CDMA, TDMA, WCDMA, LTE, EDGE, OFDM, GPRS, EV-DO, UWB, Wi-Fi, IEEE 802 including Ethernet, WiMAX, and/or others).

In some embodiments, the data system/back end components 104 in general and a server 122 in particular may include computer-executable instructions 124 stored within a memory 126 of the server 122 and/or executed using a processor 128 to create a specialized computing device. The instructions 124 may instantiate cause the system to determine and send targeted advertising and other data to the front end components 102 as herein described. In some embodiments, the modules 112, and/or other elements of the data system 104 may be implemented at least partially on the server 122 and/or the front end components 102. The data system 104 and/or processor 128 may execute instructions 124 to display advertising and other data within a display of the computing devices 118. The GUI 120 may allow a user to view or access various data within the data system 104, and/or other actions with the system data 116.

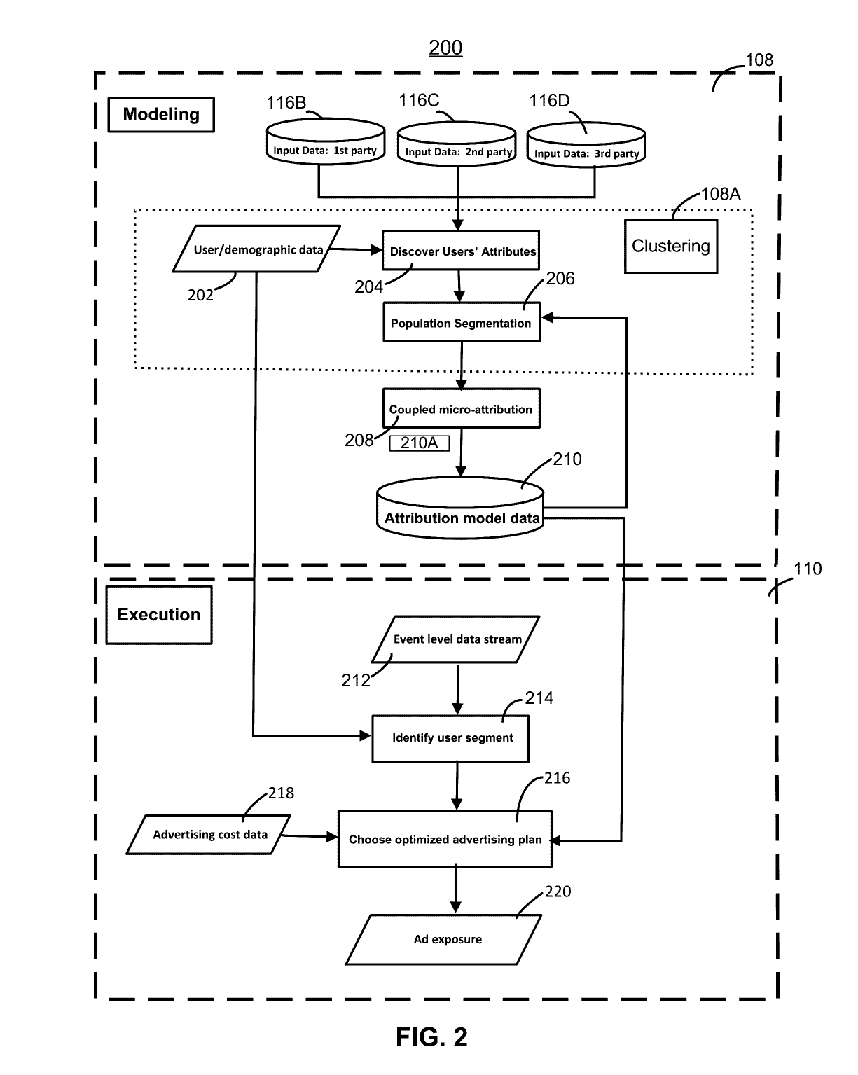

FIG. 2 is a flow chart illustrating a method for determining and sending targeted advertising and other data using the various front end components 104 to the back end components 102 as shown in FIG. 1. Each various “step” described herein may correspond to one or more computer-executable instructions of the modules 112 or 110 as executed on one or more processors such as processor 128. Steps executed by the modeling subsystem 108 may include steps 202, 204, 206, and 208, as described below. The modeling subsystem may also be divided into a clustering subsystem 108A including steps 202, 204, and 206.

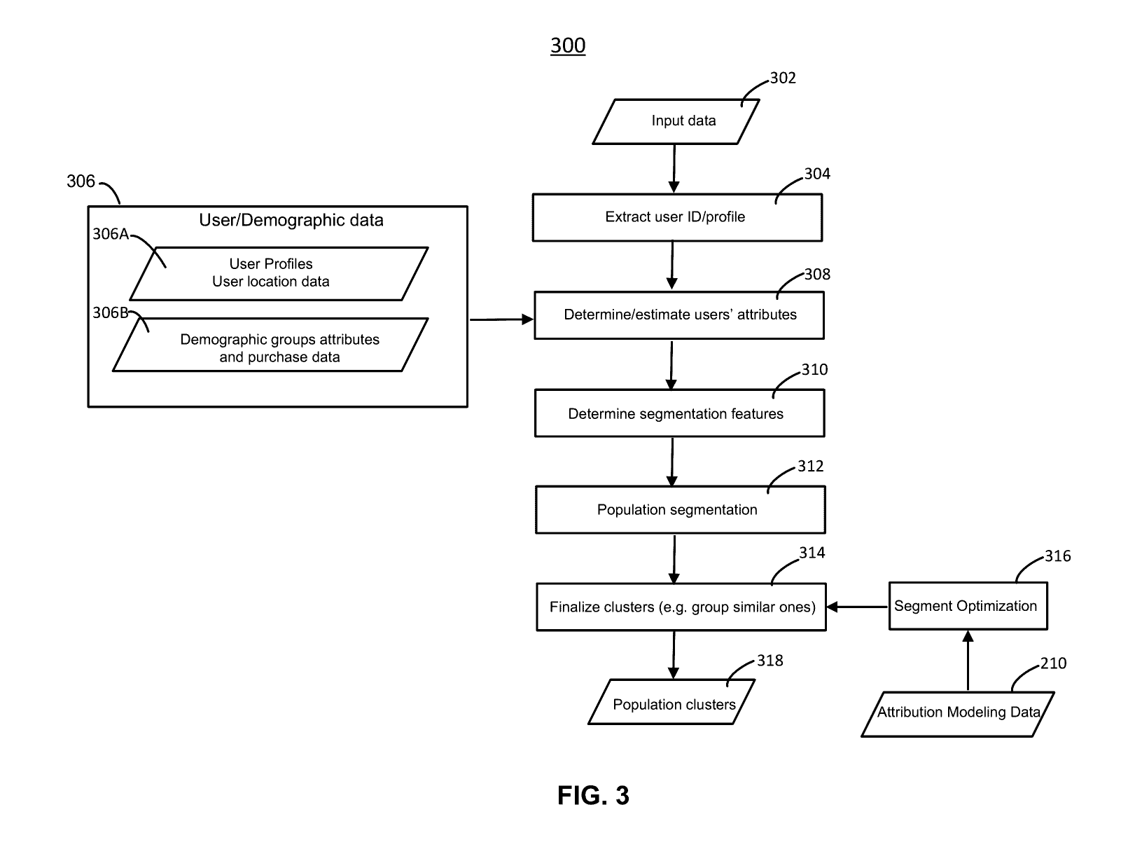

At step 202, the system 100 may execute an instruction to input a set of data which, at step 204, the system 100 may use to determine the users' attributes such as location, age, gender, interests, purchase behavior, etc. At step 206, the system 100 may execute an instruction to use the user/demographic data of step 202 and the user attributes of step 204 to divide the user population into different population segments or user clusters. The size of each population segment can be arbitrarily small down to a household. A population segment or user cluster may be a group of users with certain sets of common attributes. Step 206 is described further in relation to FIG. 3, below.

At step 208, the system 100 may perform coupled micro-attribution modeling resulting in attribution model data 210A that is stored in a database 210. In this step 208, each population segment may be analyzed or treated separately, rather than performing the modeling for all users in a single pool. Step 208 may include running an independent attribution modeling for each population segment. In this way, by focusing on a group of similar users, a more accurate model will be achieved to estimate the effect of each advertising dimension on the advertising outcomes. For example, it may be known that certain population segments who live in rural areas may be more attracted to TV, while urban population segments may be more attracted to internet. This fact calls for treating these two distinct segments in different ways. Also, in some embodiments, before the system executes step 208, multiple similar segments can be merged together to save modeling time and complexity.

Another aspect of step 208 may include coupling different dimensions in order to capture their interactions within step 208. For example, the step 208 may include determining the mutual effect of each channel and content. In this way, content within the advertising or other data may be evaluated to see which works best on each channel. Different variations of attribution modeling can be implemented at this step, also. Step 208 may also include storing the results of the corresponding attribution values for each population segment in a database 210 for future uses.

Steps executed by the execution subsystem 110 may include steps 212, 214, 216, 218, and 220, as described below. The execution subsystem 110 involves the processes performed during the real-time execution while exposing or sending advertising and/or other data to the users. Users' activity data can be obtained from different resources as available in 1^{st}, 2^{nd} or 3^{rd} party data (116A, 116B, and 116C, respectively). One example may be anonymous cookie-level data from users' internet activities. Another option for tracking user activity is the activity of registered users in an e-commerce webpage. At step 214, based on the event level data stream 212 described above, the system 100 executes instructions to infer characteristics (i.e., a probabilistic analysis of the user data) about the user, and may further assign the user data to the most suitable population segment. At step 216, the system 100 may retrieve corresponding attribution modeling results from the database 210. Based on the users' behavior and channel viewing activity and the attribution modeling results for the respective population segment, the system 100 may then execute an instruction to choose the optimal hyper-placement for ad exposure.

Hyper-placement may be defined as the unique combination or a selected subset of advertising features including channel, site, network, content, placement, time, etc., for advertising and other data exposure. In one teaching of step 216, when a user starts browsing the internet, the system 100 may execute one or more instructions to selectively show advertising or other data on websites with the highest attribution. Then, the system 100 may execute an instruction to choose the best advertising or other data and placement of that data on those selected sites. In one teaching, the system 100 executes an instruction to select the best hyper-placement to be shown according to the attributions (i.e., using the coupled attribution modeling results). In another teaching, the system 100 may use hierarchical attribution results at step 216. Using a hierarchical model, the system 100 may first execute an instruction to consider the highest-attributed advertising channels. After choosing the highest-attributed channels, the system 100 may execute an instruction to select a group of publishers in lower-attributed advertising channels. The system 100 may then execute an instruction to optimize the site and continue in a hierarchical manner to more granular levels as well.

At step 218, the system 100 may execute an instruction to use advertising cost data as an input to the ad serving optimization of step 216. In some embodiments, the system 100 may execute an instruction that employs both advertising costs data and the attribution model data to maximize the return on investment among other possible objectives. At step 220, the system 100 may execute an instruction to cause the system 100 to consider the overall budget constraint as well as constraints on any individual advertising channel/site. For example, step 220 may cause the system 100 to apply the budget constraint at both micro and macro levels. At the micro level, step 220 may cause the system 100 to execute an instruction to limit spending on each user to a certain limit. At macro levels, step 220 may cause the system 100 to execute an instruction to consider the limitation on an aggregation of ad exposures during a specific time window or on a certain channel. For example, one constraint on an advertising campaign may be a budget limit per day for the whole campaign execution. After optimizing the outcome and satisfying the cost constraints via steps 216 and 218, the system 100 may cause the proper advertising or other data to be shown at the right site to the user segment at step 220.

FIG. 3 depicts an exemplary method 300 for the population segmentation module/step 216 of FIG. 2. At step 302, an instruction may cause the system 100 to request and/or receive input data from the data warehouse 116 that includes event-level data related to the currently active users. In some embodiments, the input data is available to the system 100 as a continuous streaming feed (e.g, data stream 212). At step 304, the system 100 may execute an instruction to extract user identification data from input data feed. A form of input data may be users' profile database for those who are registered with the vendor. This identification can be completely accurate when a registered user is logged in to a website. Alternatively, the step 304 may use anonymous user identifier data.

At step 306, the method 300 may also receive/request demographic information for each geographic region 306A. For example, the data 306A may include the demographic composition of a certain geographic location. Further, the method 300 may also receive/request purchase behavior and interests' data 306B based on location and/or user profiles. Then, at step 308, the system 100 may execute an instruction to determine or estimate each user's attributes using the data 306A, 306B, and 302 and, at step 310, the system 100 may execute an instruction to determine the most important features for population segmentation from the attributes determined at step 308. At step 312, the system 100 may execute an instruction to segment the users into different categories using one or more methods including k-means, hierarchical clustering and expectation-maximization. At step 314, the system may execute an instruction to group similar clusters identified by step 312 in order to reduce the complexity by, at step 316, optimizing each segment identified at step 312 using the attribution modeling data 210 (FIG. 2). As a result of steps 312, 314, and 318, the system 100 may map each user to a population segment 318. The output of the clustering subsystem is distributing the original dataset into multiple population segments 318 to be used in the attribution modeling step 208 (FIG. 2).

Attribution modeling is a process which may determine the contribution of different influencers toward a final outcome. In advertising, the respective share of credit of each dimension (e.g., advertising channel, webpage, creative, placement, etc.) toward a user's conversion (i.e., the user's purchase of an advertised good or service, etc.), is a value that is calculated using a variety of approaches. With attribution modeling, the system 100 may determine the share of credit or the importance of each input in the users purchase funnel in order to optimize the return on marketing investment. Different approaches including rule-based, logistic regression, coalitional game theory, survival method, hidden Markov model, and support vector machine, which all may be used to implement attribution modeling.

With reference to FIGS. 2 and 3, step 208 may cause the system 100 to perform a logistic regression classification method for the attribution modeling. This model predicts the activity occurrence after being trained using available event data. Table 1 describes event data.

TABLE 1

| User | Site 1 | Site 2 | Site 3 | Converted? |
|---|---|---|---|---|
| U1 | 1 | 0 | 2 | 1 |
| U2 | 0 | 2 | 0 | 0 |
| U3 | 0 | 0 | 1 | 0 |
| U4 | 2 | 0 | 0 | 0 |
| U5 | 2 | 1 | 3 | 1 |
| U6 | 0 | 1 | 1 | 1 |

Logistic regression is a classification approach with output values of 1 and 0 for converted and non-converted users, respectively, and is described by Equation 1, below.

$$P ( x ) = \frac{1}{1 + {e}^{- ( {c}_{0} + {c}_{1} {x}_{1} + … + {c}_{n} {x}_{n} )}} \qquad EQUATION 1$$

By Equation 1, the output value will be 1 if P(x)>0.5. One must find the model coefficients (cᵢ) such that we have the best fit to the training data. After determining the model coefficients for each channel, the attributions are calculated as their corresponding normalized odds ratios. An odds ratio represents the odds that an outcome will occur given a particular exposure, compared to the odds of the outcome occurring in the absence of that exposure. Odds ratio for each variable (channel) is calculated as exp(cᵢ) where cᵢ are the corresponding coefficients for each channel in the logistic regression model. Then the attribution values will be calculated by normalizing the odds ratios as below in Equation 2:

$${a}_{i} = \frac{exp ( {c}_{i} )}{{\sum }_{i}^{ } exp ( {c}_{i} )} \qquad EQUATION 2$$

In some embodiments, the system 100 may perform the attribution modeling of step 208 separately for the different population segments determined by the method 300. This gives the system 100 the ability to adapt the marketing strategy to segments' behaviors by using the best combination of advertising dimensions according to previous experience. In this way, the system 100 performs ad serving customization using a rigorous algorithmic approach.

The coupled attribution modeling of step 208 may cause the system 100 to execute one or more instructions that separately model on different dimensions. In some embodiments, step 208 may include instructions to run independent attribution modeling for site, creative and placement. Table 1, above, and tables 2 and 3, below, illustrate the input data used for modeling site, creative, and placement attribution, respectively.

TABLE 2

| User | Creative 1 | Creative 2 | Converted? |
|---|---|---|---|
| U1 | 0 | 3 | 1 |
| U2 | 0 | 2 | 0 |
| U3 | 1 | 0 | 0 |
| U4 | 1 | 1 | 0 |
| U5 | 4 | 2 | 1 |
| U6 | 0 | 2 | 1 |

Practically, each user viewing advertising may have his or her own specific journey which may or may not lead to conversion. Table 1 describes differences between sites (i.e., site 1 or site 2) on which each user has been exposed to an ad. The system 100 may execute an instruction to run an attribution modeling for sites using these data at step 208. The outcome will be the contribution of each input on the users' conversion. Table 2 describes the differences between creative content (i.e., creative content 1 or creative content 2) on which each user has been exposed to, and Table 3 describes the placement (i.e., placement 1 or placement 2) of the advertising data within a site. For the example data of Tables 1, 2, and 3, the system 100 may employ three different models with 3, 2, and 2 features.

TABLE 3

| User | Placement 1 | Placement 2 | Converted? |
|---|---|---|---|
| U1 | 2 | 1 | 1 |
| U2 | 0 | 2 | 0 |
| U3 | 1 | 0 | 0 |
| U4 | 1 | 1 | 0 |
| U5 | 3 | 3 | 1 |
| U6 | 0 | 2 | 1 |

Generally, the instruction 208 may cause the system 100 to execute an instruction that consider n features (different inputs in each dimension, e.g. sites) which may then find each feature's corresponding attribution using the event data obtained from user activities.

The attribution modeling step 208 may also cause the system to execute an instruction where:

A^{s}=[a₁^{s},a₂^{s},aₙ^{s}]=f(x₁₁,x₂₁ . . . xₙ₁,x_{n+1,1}x₁₂,x₂₂ . . . xₙ₂,x_{n+1,2}, . . . x₁ⱼ,x₂ⱼ . . . xₙⱼ,x_{n+1,j}), . . . ,x₁ₘ,x₂ₘ . . . xₙₘ,x_{n+1,m}) EQUATION 3

Here, aᵢ^{s} corresponds to the attributions for a single dimension (e.g., site) for segment s and m corresponds to the number of users in this segment. On the right hand side of Equation 3, xᵢⱼ s are dimension event values for user j and dimension i while x_{n+1,j} is the conversion for user j.

In another embodiment, the system 100 may use hierarchical attribution as an extension to independent modeling. As below in Table 4, multiple levels of modeling may be performed for each dimension.

In this way, the system 100 may gain insight into different layers of a selected advertising feature. Too, hierarchical attribution may implement computationally intensive modeling approaches on a fewer number of inputs. For example, step 208 may cause the system 100 to execute an instruction that considers different groups of publishers and performs attribution modeling for these groups. These groups may include video streaming sites, ad agencies, news pages and specialty webpages. Going step by step from top to bottom, step 201 may cause the system 100 to focus the model on the members of each group.

TABLE 4

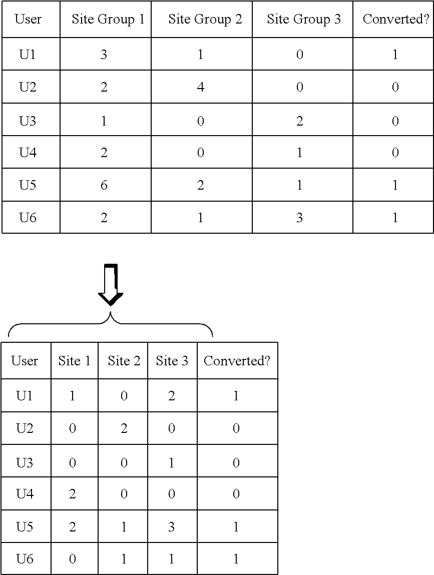

Table 5 describes another method for the attribution modeling of methods 200 and 300.

TABLE 5

| | Site 1 | | | | Site 2 | | | | Site 3 | | | | |
|---|---|---|---|---|---|---|---|---|---|---|---|---|---|
| | Creative 1 | | Creative 2 | | Creative 1 | | Creative 2 | | Creative 1 | | Creative 2 | | |
| | Plcmt | Plcmt | Plcmt | Plcmt | Plcmt | Plcmt | Plcmt | Plcmt | Plcmt | Plcmt | Plcmt | Plcmt | |
| User | 1 | 2 | 1 | 2 | 1 | 2 | 1 | 2 | 1 | 2 | 1 | 2 | Convert? |
| U1 | 0 | 0 | 0 | 1 | 0 | 0 | 0 | 0 | 0 | 0 | 1 | 1 | 1 |
| U2 | 0 | 0 | 0 | 0 | 0 | 0 | 0 | 2 | 0 | 0 | 0 | 0 | 0 |
| U3 | 0 | 0 | 0 | 0 | 0 | 0 | 0 | 0 | 1 | 0 | 0 | 0 | 0 |
| U4 | 1 | 0 | 1 | 0 | 0 | 0 | 0 | 0 | 0 | 0 | 0 | 0 | 0 |
| U5 | 1 | 1 | 0 | 0 | 0 | 1 | 0 | 0 | 1 | 0 | 0 | 2 | 1 |
| U6 | 0 | 0 | 0 | 0 | 0 | 0 | 0 | 1 | 0 | 0 | 0 | 1 | 1 |

As shown by Table 5, a cross product of a plurality of dimensions may be considered as the combined (coupled) dimension for implementing the modeling described by the methods 200 and 300. For example, if the system 100 considers site, creative and placement as the advertising dimensions, individual combinations of the values in each dimension will be the new dimension and the attribution modeling steps of the methods 200 and 300 will consider this as the input. The embodiment shown by Table 5, illustrates a single model with 3×2×2=12 features. In general, the total number of features in the coupled model is the product of the number of features in all dimensions of interest. The system 100 may treat the new combined features like ordinary features (similar to independent modeling described above) and all methods which are applicable to independent modeling are applicable here as well.

In a system 100 with three dimensions and p, q, and r features, the total number of features will be p×q×r as described by Equation 4:

A^{s}=[a₁₁₁^{s},a₁₁₂^{s}, . . . ,aₖₗᵥ^{s}, . . . ,a_{pqr}^{s}] EQUATION 4

Hence, in some embodiments, the system 100 may execute instructions to compare the effect of combining channel k, creative l, and placement v with the effect of the combination of channel k′, creative l′, and placement v′. Such a method may determine the combined effect of different inputs in a single consolidated model. On the other hand, since the system 100 performs modeling within a population segment, the effect of different attributes are also incorporated in the model. In an extension to this modeling approach, the system 100 may merge segments with similar sets of attribution values together. Further, the system 100 may use a variety of accuracy and performance criteria to validate the results of attribution modeling for each segment. A possible source of error and model deficiency for a certain segment may be due to improper or insufficient clustering attributes. In some embodiments, the system 100 may execute an instruction to send these findings to the clustering process described with reference to FIG. 3 to adjust and optimize the segments and re-run the modeling process. The system 100 may then execute an instruction to store the final results of the performed attribution modeling for each population segment in a database for later use in the execution phase described with reference to FIG. 2.

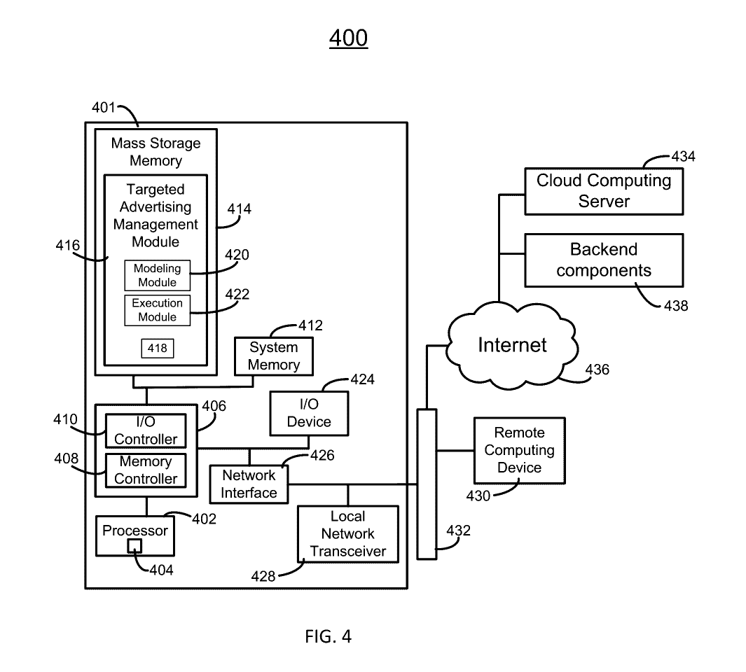

FIG. 4 is a high-level block diagram of an example computing environment 400 for the system for targeted advertising management 100 having a computing device 401 that may be used to implement the methods (200, 300) and system (100) described herein. The computing device 501 may include a server, a mobile computing device (e.g., a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example system for targeted advertising management 400 may be used to implement and execute the example system of FIG. 1, the methods of FIGS. 2 and 3, and the like. Although the example system 400 is described below as including a plurality of peripherals, interfaces, chips, memories, etc., one or more of those elements may be omitted from other example processor systems used to implement and execute the example system for targeted advertising management 100 to coordinate a construction project delivery. Also, other components may be added.

As shown in FIG. 4, the computing device 401 includes a processor 402 that is coupled to an interconnection bus. The processor 402 includes a register set or register space 404, which is depicted in FIG. 4 as being entirely on-chip, but which could alternatively be located entirely or partially off-chip and directly coupled to the processor 402 via dedicated electrical connections and/or via the interconnection bus. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus.

The processor 402 of FIG. 4 is coupled to a chipset 406, which includes a memory controller 408 and a peripheral input/output (I/O) controller 410. As is well known, a chipset typically provides I/O and memory management functions as well as a plurality of general purpose and/or special purpose registers, timers, etc. that are accessible or used by one or more processors coupled to the chipset 406. The memory controller 408 performs functions that enable the processor 402 (or processors if there are multiple processors) to access a system memory 412 and a mass storage memory 414, that may include either or both of an in-memory cache (e.g., a cache within the memory 412) or an on-disk cache (e.g., a cache within the mass storage memory 414).

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device. For example, if the computing device 401 is used to implement a target advertising management module 416 having an API 418, a modeling module 420, and an execution module 420. The mass storage memory 416 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401 and the targeted advertising management system 400. Thus, a module, block, function, operation, procedure, routine, step, and method can be implemented in hardware, firmware, and/or software. In one embodiment, program modules and routines (e.g., the modeling module 420, the API 418, the execution module 422, etc.) are stored in mass storage memory 414, loaded into system memory 412, and executed by a processor 402 or can be provided from computer program products that are stored in tangible computer-readable storage mediums (e.g. RAM, hard disk, optical/magnetic media, etc.).

The peripheral I/O controller 410 performs functions that enable the processor 402 to communicate with a peripheral input/output (I/O) device 424, a network interface 426, a local network transceiver 428, (via the network interface 426) via a peripheral I/O bus. The I/O device 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 424 may be used with the modeling module 420, the execution module 422, etc., to receive data from the transceiver 428, send the data to the backend components of the system 100, and perform any operations related to the methods 200, 300 as described herein. The local network transceiver 428 may include support for a Wi-Fi network, Bluetooth, Infrared, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 408 and the I/O controller 410 are depicted in FIG. 4 as separate functional blocks within the chipset 406, the functions performed by these blocks may be integrated within a single integrated circuit or may be implemented using two or more separate integrated circuits. The computing environment 400 may also implement the modeling module 420 and the execution module 422 on a remote computing device 430. The remote computing device 430 may communicate with the computing device 401 over an Ethernet link 432. For example, the computing device 401 may receive data from the database warehouse 116 (e.g., the 1^{st}, 2^{nd} and 3^{rd} party datasets; 116B, 116C, and 116D, respectively), the user demographic data 202, the attribution model data 210, the event level data stream 212, the advertising cost data 218, the ad exposure data 220, cluster data 318, attribution modeling data 210, etc., via the remote computing device 430. In some embodiments, the modeling module 420 and the execution module 422 may be retrieved by the computing device 401 from a cloud computing server 434 via the Internet 436. When using the cloud computing server 434, the retrieved modeling module 420 and the execution module 422 may be programmatically linked with the computing device 401. The modeling module 420 and the execution module 422 may be a collection of various software platforms including modeling software and document creation software or may also be a Java® applet executing within a Java® Virtual Machine (JVM) environment resident in the computing device 401 or the remote computing device 430. The modeling module 420 and the execution module 422 may also be “plug-ins” adapted to execute in a web-browser located on the computing devices 401 and 430. In some embodiments, the modeling module 420 and the execution module 422 may communicate with back end components 438 such as the backend components 104 of FIG. 1 via the Internet 436.

The system 400 may include but is not limited to any combination of a LAN, a MAN, a WAN, a mobile, a wired or wireless network, a private network, or a virtual private network. Moreover, while only one remote computing device 430 is illustrated in FIG. 4 to simplify and clarify the description, it is understood that any number of client computers are supported and can be in communication within the system 400.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” ro “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system for targeted advertising management for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in the appended claims.

1. A method for targeting users, optimizing, executing and monitoring one-to-one message delivery of an advertising hyper-placement along a plurality of customizable dimensions, comprising the steps of:
gathering and processing user ad impression, activity log files and user data for a plurality of users;
for each user of a subset of the plurality of users that correspond to a registered profile, determining registered user attributes and a population segment;
for each user that is not a member of the subset, determining unregistered user attributes using a probabilistic approach;
grouping the plurality of users into a plurality of groups based on the registered user attributes and the unregistered user attributes;
assigning one or more advertising hyper-placements of an advertising campaign to at least one of the plurality of groups;
determining, using attribution modeling, a share of credit to assign to each advertising hyper-placement corresponding to each of the plurality of groups; and
assigning further advertising hyper-placements to at least one of the plurality of groups based on the determined share of credit;
wherein the share of credit includes a value indicating a conversion rate for an advertising hyper-placement assigned to a group of the plurality of groups.

2. The method of claim 1, wherein the advertising hyper-placement includes one or more of marketing campaigns to increase a plurality of performance indicators including targeted traffic, sales, brand awareness, reputation and online visibility, and a marketing sale campaign.

3. The method of claim 1, further comprising optimizing the advertising hyper-placement by one or more of maximizing impact toward conversion through attribution analysis, minimizing a time to action, maximizing an ROI as objective, wherein each maximization includes a plurality of planning parameters as optimization variables.

4. The method of claim 3, wherein optimizing the advertising hyper-placement includes building a model that relates objective and planning parameters of each advertising hyper-placement using historical data and a plurality of machine learning algorithms.

5. The method of claim 4, wherein the historical data includes historical data of one or more other advertising campaigns that are one of:
similar to the advertising campaign of the advertising hyper-placements for the same advertiser,
different from the advertising campaign of the advertising hyper-placements for the same advertiser,
different from the advertising campaign for a vertical corresponding to the same advertiser,
different from the advertising campaign for a publisher corresponding to the same advertiser, or
all advertising campaigns in a marketplace.

6. The method of claim 5, wherein the model further uses survey, census, and panel data describing probability distribution functions of various parameters including one or more of a user's behavior and a user's demography.

7. The method of claim 6, further comprising monitoring the advertising campaign including visualizing, reviewing, and analyzing a plurality of aspects of the advertising campaign and parameters of the advertising campaign before, during and after an execution of the advertising campaign.

8. The method of claim 1, further comprising directly communicating the assigned one or more advertising hyper-placements and the further advertising hyper-placements from a plurality of publishers to the subset of the plurality of users, wherein the subset includes at least one user.

9. The method of claim 8, wherein directly communicating the assigned one or more advertising hyper-placements and the further advertising hyper-placements from the plurality of publishers to the subset of the plurality of users includes communicating the assigned one or more advertising hyper-placements and the further advertising hyper-placements from the plurality of publishers to the subset of the plurality of users along one or more customizable dimensions including an advertising channel, an advertising content, an advertising time, an advertising promotional content, an advertising investment amount, one or more trade parameters, and a measure of advertising effectiveness.

10. The method of claim 9, wherein the one or more customizable dimensions includes one or more different levels of granularities including one or more of:
a placement for channels,
an image, a flash, a rich media, and a video for content,
airing time for time.

11. The method of claim 1, further comprising optimizing the advertising hyper-placement by attributing the share of credit to the one or more customizable dimensions through an attribution model.

12. The method of claim 11, further comprising customizing the attribution model for one or more subsets of the plurality of users.

13. The method of claim 12, further comprising implementing the attribution model independently on the one or more customizable dimensions or implementing the attribution model as a coupled analysis on a plurality of the customizable dimensions.

14. The method of claim 1, further comprising optimizing the advertising hyper-placement by merging a plurality of subsets of the plurality of users, wherein each of the plurality of subsets includes one or more identical attribution values to optimize a balance between granularity of the subsets and accuracy of the attribution model.

15. The method of claim 14, further comprising co-optimizing the attribution model by at least one of:
optimizing the advertising hyper-placement by building a model that relates objective and planning parameters of each advertising hyper-placement using historical data and a plurality of machine learning algorithms; and
optimizing the advertising hyper-placement by attributing the share of credit to the one or more customizable dimensions through the attribution model.

16. A networked system comprising a processor, a memory and an input-output circuit for enabling a modeling module to deliver an advertising hyper-placement along a plurality of customizable dimensions, the processor being physically configured according to computer executable instructions for:
receiving at the processor an execute action to an execution subsystem to start the modeling module;
gathering and processing, through the processor, user ad impression, activity log files and user data for a plurality of users;
for each user of a subset of the plurality of users that correspond to a registered profile, determining, at the processor, registered user attributes and a population segment;
for each user that is not a member of the subset, determining, at the processor, unregistered user attributes using a probabilistic approach;
grouping, at the processor, the plurality of users into a plurality of groups based on the registered user attributes and the unregistered user attributes;
assigning, at the processor, one or more advertising hyper-placements of an advertising campaign to at least one of the plurality of groups;
determining, at the processor, using attribution modeling, a share of credit to assign to each advertising hyper-placement corresponding to each of the plurality of groups; and
assigning, at the processor, further advertising hyper-placements to at least one of the plurality of groups based on the determined share of credit;
wherein the share of credit includes a value indicating a conversion rate for an advertising hyper-placement assigned to a group of the plurality of groups.

17. A method for targeted advertisement delivery along a plurality of customizable dimensions comprising:
determining user attributes based on user data corresponding to a plurality of users, the user data from interactions with one or more of online media and offline media of the plurality of users;
determining a plurality of population segments based on the user attributes, wherein each of the plurality of population segments corresponds to at least one of the user attributes for each user of the plurality of users;
analyzing each population segment separately from the plurality of population segments; and
selecting an advertising hyper-placement for each of the plurality of users based on the population segment analysis.

18. The method of claim 17, wherein the user data includes one or more of event log files gathered from users during online or offline interaction with an advertising campaign of interest, data files corresponding to a first client gathered through opt-in agreements of a second client, and conversion data describing action taken by users as a result of receiving targeted advertising data.

19. The method of claim 17, wherein each population segment includes a plurality of users having a set of common user attributes.

20. The method of claim 19, further comprising probabilistically analyzing the user attributes to determine the population segment.

21. The method of claim 19, wherein analyzing each population segment separately from the plurality of population segments includes running an independent attribution modeling for each population segment.

22. The method of claim 21, wherein running the independent attribution modeling for each population segment determines a share of credit that should be assigned to each advertising hyper-placement.

23. The method of claim 21, wherein running the independent attribution modeling for each population segment includes coupling two or more of the determined user attributes.

24. The method of claim 23, wherein coupling two or more of the determined user attributes includes determining an attribution A^{s} of the targeted advertising data where:
A^{s}=[a₁₁₁^{s},a₁₁₂^{s}, . . . ,aₖₗᵥ^{s}, . . . ,a_{pqr}^{s}]
for the effect of combining channel k, creative l, and placement v with the effect of the combination of channel k′, creative l′, and placement v′ for the features p, q, and r, the features including one of channel, site, network, content, placement, or time.
